(19) United States
(12) Patent Application Publication
(10) Pub. No.: US 2006/0046107 A1
(43) Pub. Date: Mar. 2, 2006

(54) System for fuel cell power plant load following and power regulation

(75) Inventor: Robert Wayne Lindsey, Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 10/931,032

(22) Filed: Sep. 1, 2004

(51) Int. Cl. H01M 8/04

(52) U.S. Cl. 429/13; 429/22; 429/23

(57) ABSTRACT

Methods and systems are provided to control a fuel cell power plant system to provide load following capabilities and to improve power plant availability. In one embodiment, a method is performed for controlling a fuel cell power plant system. The process includes controlling a variable load bank capable of absorbing output power from the fuel cell power plant such that the total load on the fuel cell power plant is constant, wherein the total load is a combination of an external load connected to the power plant and a load on the variable load bank. Further, the process may include maintaining a constant chemical reaction rate of the fuel cell power plant while maintaining a desired total load.

### TECHNICAL FIELD

This disclosure relates generally to power plant and load management systems, and particularly to methods and systems for providing load following capability and high availability for fuel cell power plants.

### BACKGROUND

Fuel cell power plants have many advantages over conventional types of power plants. Particularly, most fuel cell power plants are more efficient and environment friendly than their conventional counterparts, since the fuel cell uses a catalyzed reaction between a fuel and an oxidizer to directly produce electricity. In order to continuously provide power to external consumers, fuels are continuously fed to fuel stacks of a fuel cell power generator based on a chemical reaction rate between the fuel and the oxidizer. When the electrical load on a fuel cell changes, chemical reactions must occur to maintain the output power level provided by the fuel cell. During operations of fuel cell power plants, such as those made of Molten Carbonate Fuel Cells (MCFC), an external electrical load has to be relatively constant so that the load and the chemical reaction rate are balanced. Due to slow chemical and thermal reactions within the fuel cell, the external electrical load often changes at a rate different than the chemical reaction rate. Thus, an unbalanced condition can exist within the fuel cell. The unbalanced condition may shorten the service life of the fuel cell power plant and may also reduce its performance as well.

Fuel cell power plants may operate in grid-connected mode or a grid-disconnected or “island” mode. When operating in grid-connected mode, load changes are shared by other power plants in the grid. However, when operating in grid-connected mode, load following characteristics are still desirable because fluctuations of the external load may extend beyond the safety tolerance of the fuel cell power plant. This again will cause the unbalanced condition and, therefore, affect the performance of the fuel cell power plant. Generally, a utility management relay monitors the grid for normal voltages. If grid conditions are out of tolerance, the relay disconnects the power plant as a safety precaution. Once the fuel cell power plant is disconnected from the grid, the chemical reaction has to be completely shut down. The power plant then has to go through a “dwell” cycle, which limits the availability of the plant for a period up to 10 hours before the power plant can provide power to the grid again.

When the fuel cell power plant operates in grid-disconnected or “island” mode, load following characteristics are even more desirable, since the external load changes are not compensated by other power plants. The unbalanced condition between the external load change and the fuel cell chemical reaction rate happens more frequently in grid-disconnected mode than in grid-connected mode.

Methods and systems have been created by the industry to address the problems rising from the unbalanced condition between the external load change and the fuel cell chemical reaction rate. Some methods increase the reaction time period so that the fuel cell power plant has enough time to adjust the chemical reaction to match the external load demand, such as described in Published Japanese Patent Application 09-251858 to Nagasawa Makoto. Some fuel cell technologies do not exhibit the unbalanced conditions due to faster reaction times. However, these methods and systems generally increase the complexity and cost of the fuel cell power plant and its management systems.

Methods and systems consistent with certain embodiments are directed to solving one or more of the problems set forth above.

### SUMMARY OF THE INVENTION

In one embodiment, a method is performed for controlling a fuel cell power plant system. The process includes controlling a variable load bank capable of absorbing output power from the fuel cell power plant such that the total load on the fuel cell power plant is constant, wherein the total load is a combination of an external load connected to the power plant and a load on the variable load bank. Further, the process may include maintaining a constant chemical reaction rate of the fuel cell power plant while maintaining a constant total load.

In another embodiment, a system is provided for controlling a fuel cell power plant system. The system includes a fuel cell providing electric power and a load bank for dissipating power from the fuel cell. The system may also include an inverter controller for adjusting the load operations of the load bank based on detected changes to an external load receiving power from the fuel cell power plant and a fuel cell controller for maintaining a constant chemical reaction rate of the fuel cell despite load changes to the external load.

### BRIEF DESCRIPTION OF THE DRAWINGS

The accompanying drawings, which are incorporated in and constitute a part of this specification, illustrate several aspects of the invention and together with the description, serve to explain the principle of the invention. In the drawings:

FIG. 1 illustrates a block diagram of an exemplary fuel cell power plant system consistent with certain disclosed embodiments;

FIG. 2 illustrates a block diagram of an exemplary inverter controller module consistent with certain disclosed embodiments;

FIG. 3 illustrates a flowchart diagram of an exemplary method to provide load following capabilities consistent with certain disclosed embodiments; and

FIG. 4 illustrates a flowchart diagram of an exemplary method to provide capabilities consistent with certain disclosed embodiments.

### DETAILED DESCRIPTION

Reference will now be made in detail to the exemplary aspects of the invention, examples of which are illustrated in the accompanying drawings. Wherever possible, the same reference numbers will be used throughout the drawings to refer to the same or like parts.

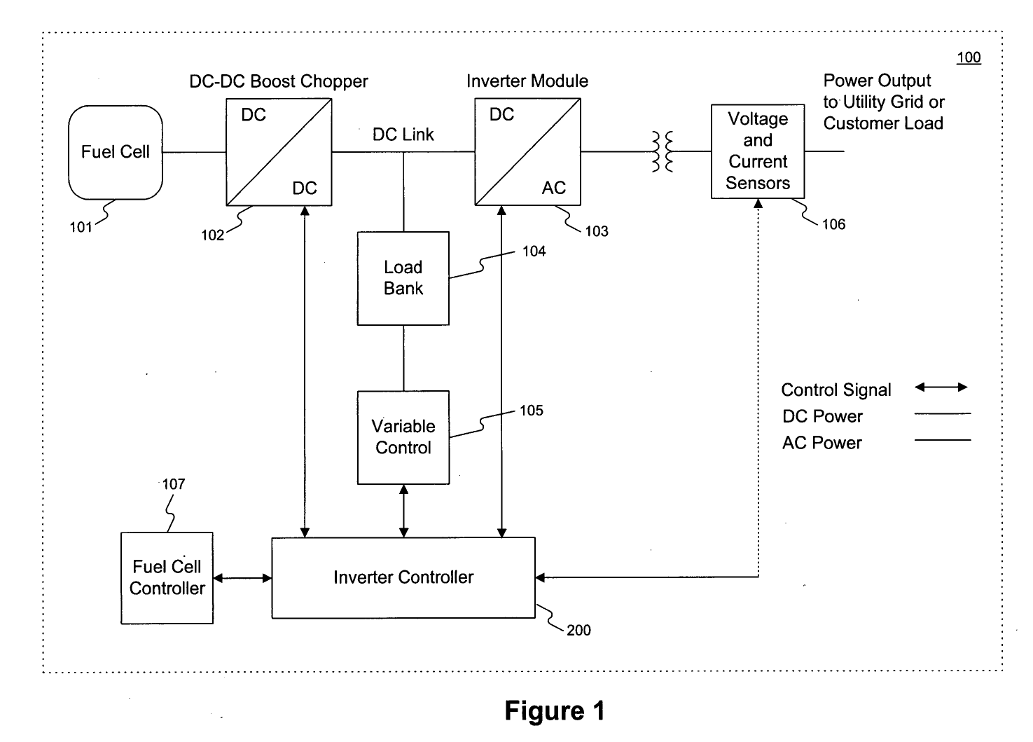

FIG. 1 illustrates an exemplary fuel cell power plant system 100 consistent with certain disclosed embodiments. As shown in FIG. 1, fuel cell power plant system 100 may include fuel cell 101, DC-DC boost chopper 102, inverter module 103, load bank 104, variable control unit 105, voltage and current sensors 106, fuel cell controller 107, and inverter controller module 200.

Fuel cell 101 generates DC electricity by using fuel cell technology. Fuel cell 101 may include a plurality of fuel cell stacks and associated fuel processing units. The fuel cell stacks in fuel cell 101 may use any type of fuel cell technologies, such as Proton Exchange Membrane Fuel Cell (PEMFC), Alkaline Fuel Cell (AFC), Phosphoric-Acid Fuel Cell (PAFC), Solid Oxide Fuel Cell (SOFC), or Molten Carbonate Fuel Cell (MCFC), etc. The output electricity of fuel cell 101 is provided to DC-DC boost chopper 102 or to inverter module 103. DC-DC boost chopper 102 raises the voltage level of the output electricity to a desirable level under the control of inverter controller 200. The output DC power from DC-DC boost chopper 102 or inverter module 103 is then converted into AC power by the inverter module 103 under the control of inverter controller 200. The converted AC power is then outputted to a utility grid or customer load. Inverter module 103 may be any standard inverter module used in the fuel cell power plant or customized inverter module providing specified control (i.e., configured to perform according to predetermined specifications).

A load bank 104 is connected to a DC link between DC-DC boost chopper 102 or fuel cell 101 and inverter module 103. Load bank 104 provides durable and accurate energy dissipation for sources generating electrical power. Load bank 104 may include modular energy dissipation units, cooling systems (with or without cooling fans, or water-cooled), monitoring capabilities, and control systems. Load bank 104 may be switched online as needed with multi-stage contactors, or electronic switching devices such as IGBT's or FET's, providing graduated control and circuit protection. Load bank 104 may allow loads to be progressively applied in increments up to the full load, thereby preventing large current spikes. Further, load bank 104 may be varied continuously. Also, the response time of load bank 104 may be minimized such that changes in load bank 104 can be quickly reflected in the fuel cell output power, unlike the longer load change response time of fuel cell 101. Load bank 104 may also provide extra thermal energy if desirable.

Load bank 104 is connected to variable control unit 105, which controls all the aspects of changing the load of load bank 104. Variable control unit 105 may be a standard or customized system that provides additional control means under the direction of inverter controller 200.

Voltage and current sensors 106 monitor operations of a grid to detect any abnormal conditions of the grid when fuel cell power plant 100 operates in grid-connected mode. Further, voltage and current sensors 106 monitor the customer load when fuel cell power plant 100 operates in a grid-disconnected mode. Voltage and current sensors 106 may be any standard sensor components or may be customized sensors configured for particular monitoring operations. The data from the voltage and current sensors 106 are read and processed by inverter controller 200.

Fuel cell controller 107 controls operations of fuel cell 101. Fuel cell controller 107 may communicate to inverter controller 200 the operational status of fuel cell power plant 100 and certain actions to be performed by fuel cell power plant 100 based on predetermined logic and event analysis processes. Fuel cell controller 107 may maintain a desired chemical reaction rate of the fuel cell, e.g. a constant rate, if the load on fuel cell power plant 100 is maintained at a desired level, e.g. a constant level, or upon a request from inverter controller 200.

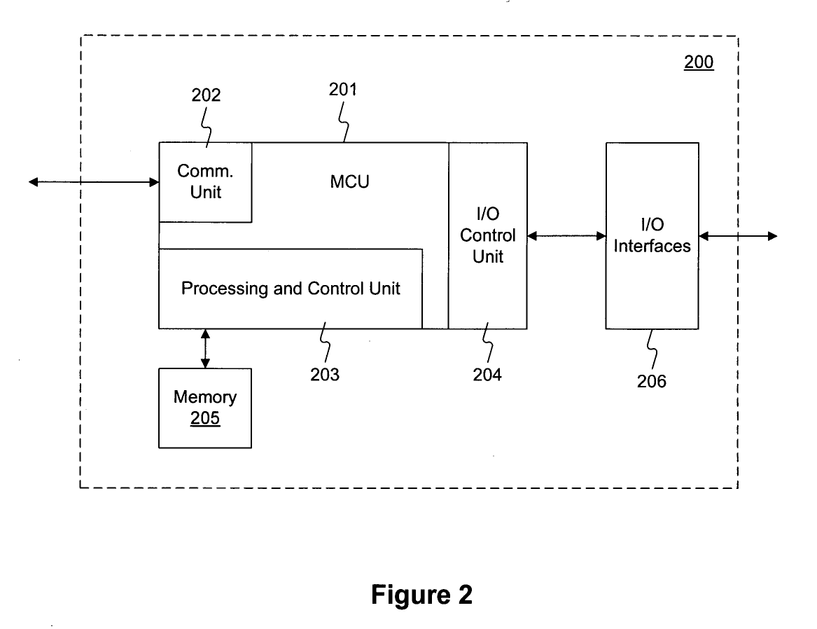

As shown in FIG. 2, inverter controller module 200 may include microcontroller 201, which may include communication unit 202, processing and control unit 203, and I/O control unit 204. Microcontroller 201 may also include onboard memory 205, such as typically used by a processor for startup or normal processing operations. Microcontroller 201 may be configured as a separate processor module dedicated to perform inverter control functions, or alternatively, it may be configured as a shared processor module performing other functions unrelated to the inverter control functions. Processing and control unit 203 performs control algorithms and calculations to control DC-DC boost chopper 102, load bank 104, variable control unit 105, inverter module 103, and sensors 106. The program implementing the control algorithms and calculations may be stored within microcontroller 201 or memory 205.

Memory 205 may be one or more memory devices including, but not limited to, ROM, flash memory, dynamic RAM, and static RAM. Memory 205 may be configured to store information used by microcontroller 201.

I/O control unit 204 controls I/O interface 206, which may be one or more input/output interface devices receiving data from microcontroller 201 and sending data to microcontroller 201 from various external devices, such as DC-DC boost chopper 102, load bank 104, variable control unit 105, inverter module 103, and sensors 106. Communication unit 202 also provides inter-processor communications so that microcontroller 201 can communicate with other processors in fuel cell power plant system 100, such as fuel cell controller 107, via any suitable standard or proprietary communication protocols. Communication unit 202 may also communicate with other computer systems whenever applicable.

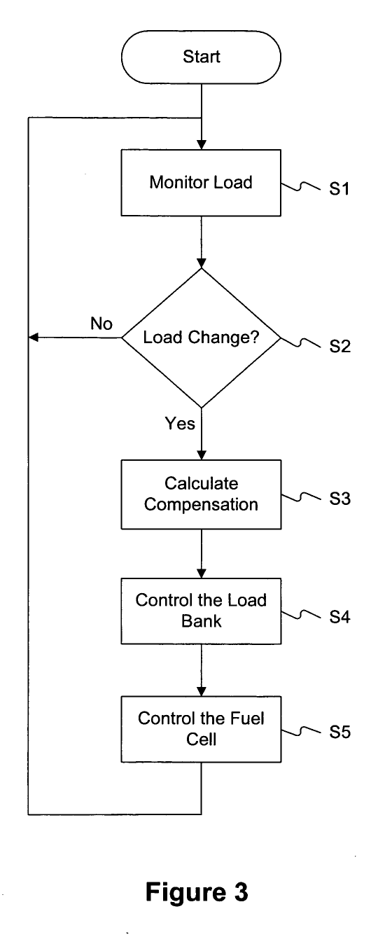

FIG. 3 illustrates a flowchart of a load following capability process consistent with certain disclosed embodiments. In one embodiment, inverter controller 200 may perform the load following capability process to improve power availability of fuel cell power plant 100. As shown in FIG. 3, in step 310, inverter controller 200 continuously monitors an external load via voltage and current sensors 106. The external load may be a shared load from a grid connected to fuel cell power plant 100, or may be a direct customer load depending on whether fuel cell power plant 100 operates in either grid-connected or grid-disconnected mode.

In step 320, inverter controller 200 compares the collected sensor data to previously stored sensor data or to the pre-determined threshold data to determine whether the external load has changed. If the external load does not change or the change is within a pre-determined range compared to the threshold data (Step 320; No), the load following capability process returns to step 310 for subsequent sensor monitoring. However, if the external load changes beyond the pre-determined range (Step 320; Yes), inverter controller 200 determines the amount of change experienced on the external load.

Further, inverter controller 200 determines the total capacity of the load bank 104 and checks the status of load bank 104. Based on these determinations and analysis, inverter controller 200 calculates the amount of load changes from load bank 104 needed to compensate for the change on the external load in order to maintain the net sum of the load on the fuel cell at a constant level (Step 330). If the external load demand decreases, inverter controller 200 determines the amount of load from load bank 104 to be added in order to deviate the power from the external load. On the other hand, if the external load demand increases, inverter controller 200 determines the amount of load to be removed in order to divert the power to the external load. Then in step 340, inverter controller 200 sends control commands to variable control unit 105 to adjust load bank 104 according to the calculations performed in step 330.

In step 350, inverter controller 200 controls fuel cell 101 by determining whether fuel cell controller 107 should be instructed to change the fuel cell reaction rate to react to the external load changes. For example, during normal operations, the fuel cell reaction rate may be kept constant. Under certain conditions, however, inverter controller 200 may communicate with fuel cell controller 107 such that the fuel cell reaction rate is adjusted to compensate for the external load changes experienced by fuel cell power plant 100.

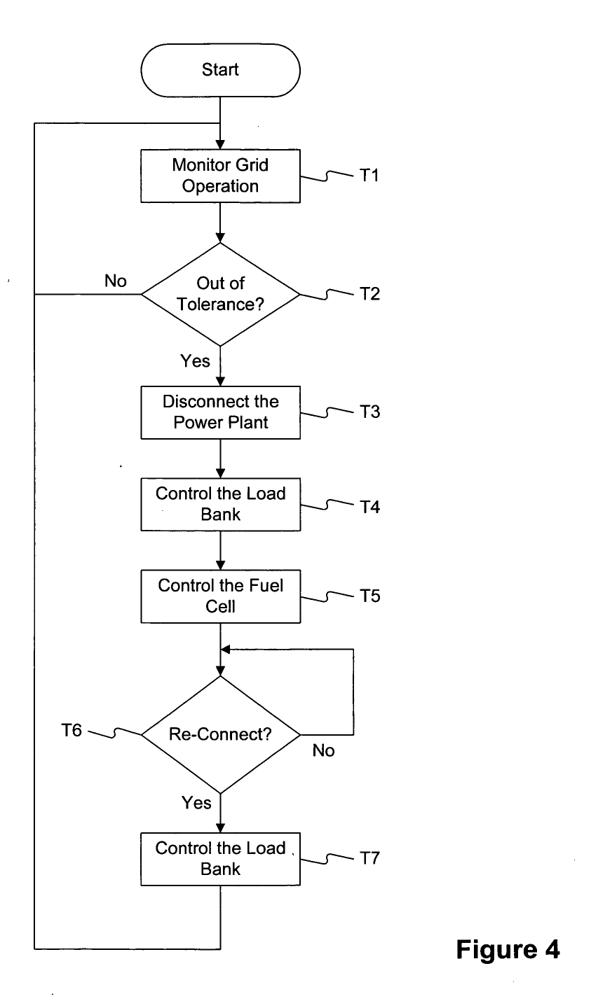

In addition to load following processes, inverter controller 200 may also perform power grid availability processes for a grid-connected fuel cell power plant 100. FIG. 4 illustrates a flowchart of an exemplary grid availability process performed by inverter controller 200. These steps are exemplary and not intended to be limiting. Other steps may be added or removed and the sequence of the steps may be changed. As mentioned, fuel cell power plant 100 may operate in a grid-connected mode. Accordingly, inverter controller 200 may monitor the operations of the power plant grid (e.g., voltage levels, etc.) (step 410). In one embodiment, inverter controller 200 may monitor the grid through voltage and current sensors 106. That is, inverter controller 200 may collect sensor data collected by sensors 106. Inverter controller 200 then compares the sensor data with previously stored sensor data or predetermined threshold data to determine whether any detected external voltage and current changes are out of tolerance (i.e., changes in voltage and current exceed predetermined levels or range values) (step 420). If the external voltage and current do not change or the change is within a predetermined tolerance range (step 420; No), the grid availability process returns to step 410 for continued monitoring. However, if the external voltage and current change beyond the pre-determined safety tolerance range (step 420; Yes), inverter controller 200 may disconnect fuel cell power plant 100 from the grid (step 430). Disconnecting fuel cell power plant 100 may include performing processes needed to disconnect the fuel cell power plant 100 from the grid.

In step 440, inverter controller 200 directs variable control unit 105 to control load bank 104 to absorb the entire output DC power from fuel cell 101. Further, inverter controller 200 may determine whether fuel cell controller 107 should change the fuel cell reaction rate to react to the external load changes (step 450). During normal operations, the fuel cell reaction rate may be kept constant. However, under certain conditions, inverter controller 200 may direct fuel cell controller 107 to adjust the fuel cell reaction rate.

In step 460, inverter controller 200 determines whether fuel cell power plant 100 should be reconnected to the grid. This analysis may be performed based on sensor data reflecting whether the external voltage and current are within a determined tolerance or by receiving an external command from an external input device (not shown) or from an external control module (not shown). If reconnection is not required (step 460; No), inverter controller 200 may delay for a pre-determined time period before determining whether to reconnect fuel cell power plant 100 to the grid. If reconnection is required (step 470; Yes), inverter controller 200 directs variable control unit 105 to control load bank 104 in order to gradually divert the output DC power from fuel cell 101 back to the grid until the output power matches the external load demand (step 470).

Inverter controller 200 may also operate in a grid-connected mode where it is desirable to reduce or regulate the output power to the grid while maintaining a set power level from fuel cell 101. Any excessive power is dissipated by load bank 104 and regulated by inverter controller 200.

### INDUSTRIAL APPLICABILITY

Methods and systems consistent with the disclosed embodiments may facilitate the development of new fuel cell products by providing efficient and low cost power and load control mechanisms. In one embodiment, the methods and systems may be used in stationary fuel cell power plants to provide load following capabilities and grid availabilities for reducing lengthy dwell cycles that occur during reconnection of the fuel cell power plant to a power plant grid.

In another embodiment, the disclosed methods and systems may be used in mobile fuel cell power plants to provide load following capabilities and load control mechanisms to reduce lengthy dwell cycles for very large load changes in a work machine.

Further, disclosed embodiments may be used in fuel cell appliances to provide load following capabilities that reduce lengthy dwell cycles for load changes in appliances.

Other embodiments, features, aspects, and principles of the disclosed exemplary systems may be implemented in various environments. Embodiments other than those expressly described herein will be apparent to those skilled in the art from consideration of the specification and practice of the disclosed systems.

1. A method for controlling a fuel cell power plant, comprising:
controlling a variable load bank capable of absorbing output power from the fuel cell power plant such that the total load on the fuel cell power plant is maintained at a desired level, wherein the total load is a combination of an external load connected to the power plant and a load on the variable load bank; and
maintaining a desired chemical reaction rate of the fuel cell power plant while maintaining a desired total load.

2. The method in claim 1, wherein the fuel cell power plant operates in a power plant grid including other power plants, and wherein prior to the step of controlling a variable load bank, the method includes:
monitoring the operation of the power plant grid.

3. The method in claim 1, wherein prior to the step of controlling a variable load bank, the method further includes:
monitoring a customer load connected to the power plant.

4. The method in claim 1, wherein the load bank is continuously variable.

5. The method in claim 1, wherein a load following response time of the variable load bank is less than a following response time of the fuel cell load following response time.

6. The method in claim 1, wherein the step of controlling the variable load bank further includes:
determining a change in demand on the external load;
calculating a load compensation needed from the variable load bank such that the net load on the fuel cell power plant is maintained at a desired level; and
adjusting the variable load bank based on the calculated load compensation.

7. A method for performing a grid-availability process in a grid-connected fuel cell power plant, comprising:
monitoring conditions of a power plant grid connected to the fuel cell power plant;
detecting an out-of-tolerance grid condition based on the monitoring;
disconnecting the fuel cell power plant from the grid based on the detecting; and
controlling a load bank to absorb output power of the fuel cell power plant to prevent power deviation from the fuel cell power plant.

8. The method in claim 7, further including:
gradually diverting power from the load bank to the grid until an external load demand is met.

9. The method in claim 7, further including:
gradually diverting non-deviated power from the load bank to the external load.

10. A system for providing load following capabilities and improved availability for a fuel cell power plant comprising:
means for controlling a variable load bank capable of absorbing output power from the fuel cell power plant such that the total load on the fuel cell power plant is maintained at a desired level, wherein the total load is a combination of an external load connected to the power plant and a load on the variable load bank; and
means for maintaining a desired chemical reaction rate of the fuel cell power plant while maintaining a desired total load.

11. The system in claim 10, further comprising
means for monitoring the operation of the power plant grid.

12. The system in claim 10, further comprising
means for monitoring a customer load connected to the power plant.

13. The system in claim 10, wherein the load bank is continuously variable.

14. The system in claim 10, wherein a load following response time of the variable load bank is less than a following response time of the fuel cell load following response time.

15. The system in claim 10, wherein the means for controlling the variable load bank further includes:
means for determining a change in demand on the external load;
means for calculating a load compensation needed from the variable load bank such that the net load on the fuel cell power plant is maintained at a desired level; and
means for adjusting the variable load bank based on the calculated load compensation.

16. A system for controlling power in a fuel cell power plant, comprising:
a fuel cell providing electric power;
a variable load bank for dissipating power from the fuel cell;
an inverter controller for adjusting the load operations of the variable load bank based on detected changes to an external load receiving power from the fuel cell power plant; and
a fuel cell controller for maintaining a constant chemical reaction rate of the fuel cell despite load changes to the external load.

17. The system in claim 16, further including:
a DC-DC boost chopper for elevating an output power from the fuel cell to a predetermined voltage level.

18. The system in claim 16, wherein the inverter controller further includes:
a memory storing program code to perform a load following process and a grid availability process; and
a microcontroller for executing the program code to control power in the fuel cell power plant.

19. The system in claim 16, further including:
a load bank controller for adjusting the load from the variable load bank.

20. The system in claim 19, wherein the load bank controller is controlled by the inverter controller to adjust the load of the variable load bank.

21. The system in claim 16, further including:
voltage and current sensors for monitoring operation conditions of the external load to the fuel cell power plant.

22. The system in claim 21, wherein the inverter controller controls the variable load bank based on monitoring data from the voltage and current sensors.

23. A power control and regulation system for a fuel cell power plant, comprising:
a fuel cell configured to provide electric power;
a DC-DC boost chopper coupled to receive the electric power from the fuel cell on an input line, and to provided boosted electric power on an output line;
an inverter module coupled to the output line of the DC-DC boost chopper to receive the boosted electric power on an input line, and to provide converted electric power on an output line;
a variable load bank, having an input line and a control line, coupled to the output line of the DC-DC boost chopper and to the input line of the inverter module on the input line;
a variable control coupled to the control line of the variable load bank to adjust the load of the load bank; and
an inverter controller coupled to control the DC-DC boost chopper, the inverter module, and the variable control.

23. (canceled)

24. The system in claim 23, further including:
voltage and current sensors coupled to the output line of the inverter module to monitor the electric power, and coupled to the inverter control to send sensor data.

25. The system in claim 23, further including:
a fuel cell controller coupled to communicate with the inverter controller.
